(19) United States
(12) Patent Application Publication
(10) Pub. No.: US 2009/0157396 A1
(43) Pub. Date: Jun. 18, 2009

(54) Voice data signal recording and retrieving

(75) Inventor: Elias BJARNASON, Grasbrunn (DE)

Correspondence Address: INFINEON TECHNOLOGIES AG;Patent Department, MUC 11.1.507, P.O. Box 221644, Munich, 80506, DE

(73) Assignee: INFINEON TECHNOLOGIES AG, Muenchen (DE)

(21) Appl. No.: 11/957,508

(22) Filed: Dec. 17, 2007

(51) Int. Cl. G10L 19/04; G10L 19/00

(52) U.S. Cl. 704/211; 704/201; 704/219; 704/E19.023

(57) ABSTRACT

Embodiments related to recording and retrieving of voice data signals are described and depicted.

### BACKGROUND

In many devices and systems voice data is stored and retrieved after storing. For example, in communication systems such as mobile phones, wireless phones or voice recording and playback systems, voice signals are stored in external or internal memories and retrieved from same for further processing, for transmission over communication channels or simply to allow time-shifted listening of the voice data signal for the user. Depending on the application, the memory has to be designed significantly large to allow storing of all incoming data resulting in additional costs depending on the size of memory required.

For storing of the voice signals, audio encoding methods may be used prior to storing the voice signals. Audio encoding methods can be lossless and lossy encoding. Audio encoding methods are defined and described in standards such as the ITU G.7XX standards (where X is to be replaced by a number from 1 to 9) including encoding methods such as DPCM (differential pulse code modulation) or ADPMC (adaptive DPCM). Although audio encoding provides data compression to some degree prior to digital storing, it would be advantageous to have a more efficient recording of signals to allow a further reduction in the size of the memories.

### SUMMARY

According to one aspect, an apparatus comprises an input to receive a first signal. An entity is coupled to the input to provide speech manipulating processing and encoding processing for the first signal. Furthermore, memory is coupled to the entity.

According to another aspect a method comprises receiving of a first signal and generating a second signal by providing for the first signal a speech modification processing and encoding processing. After the speech modification processing and encoding processing, digital information contained in the second signal is stored in a memory.

According to another aspect, a communication system includes an input to receive a signal and a recording device to record the signal. The recording device has an entity coupled to the input to provide speech-manipulating processing and encoding processing for the signal and a memory coupled to the entity to store information contained in the speech-manipulated and encoded output signal of the entity.

### BRIEF DESCRIPTION OF THE SEVERAL VIEWS OF THE DRAWINGS

FIG. 1 shows a block diagram according to an embodiment of the present invention;

FIG. 2 shows a flow chart diagram according to an embodiment of the present invention;

FIG. 3 shows a block diagram of an apparatus according to an embodiment of the present invention;

FIG. 4 shows a block diagram of an apparatus according to an embodiment of the present invention; and

FIG. 5 shows a block diagram of an apparatus according to an embodiment of the present invention.

### DETAILED DESCRIPTION

The following detailed description explains exemplary embodiments of the present invention. The description is not to be taken in a limiting sense, but is made only for the purpose of illustrating the general principles of embodiments of the invention while the scope of protection is only determined by the appended claims.

In the various figures, identical or similar entities, modules, devices etc. may have assigned the same reference number.

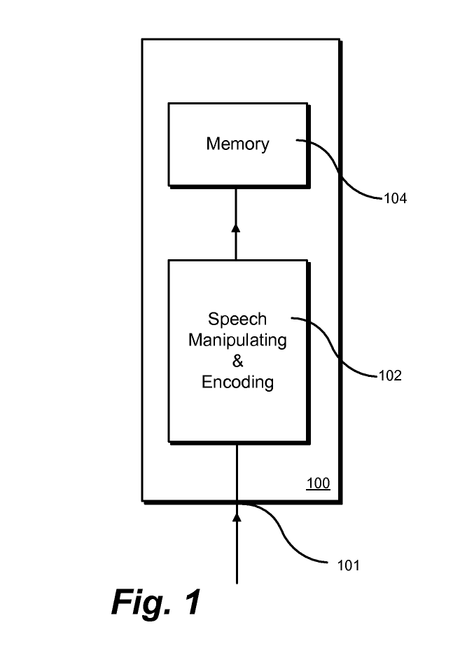

Referring now to FIG. 1, a basic block diagram of an exemplary embodiment is shown. FIG. 1 shows an apparatus 100 having an input 101 to receive a first signal. Apparatus 100 may be for example a speech recording device, a communication device such as a wireless phone, a mobile phone with speech recording capabilities, a wireless basis station with speech recording capacities for example according to the DECT standard etc.

The apparatus 100 includes an entity 102 to provide speech manipulating processing and encoding processing for the first signal. As will be outlined in more detail below, by providing speech manipulation in addition to encoding, a higher compression rate of a voice data stream can be achieved resulting in a more efficient storage of the voice signal and/or reducing memory size requirements for storing the voice signal. As will be described in more detail below, the entity 102 may be configured to provide the speech manipulating processing separate from the encoding processing. For example the speech manipulating may be provided prior to the encoding processing. According to a further embodiment, the entity may be configured to provide a combined speech manipulating and encoding processing for the first signal wherein the speech manipulating is processed during the encoding processing. By simultaneously providing speech manipulating and encoding, an efficient recording or retrieving of signals can be achieved.

The speech manipulating may according to one embodiment be a fast-playback processing such as a LPC (linear predictive coding). According to one embodiment, the speech manipulating may be based on and may exploit the predictable nature of speech signals such as the periodic nature of pitches in vocals. Cross-correlation, autocorrelation, and autocovariance may be used to determine this predictability. After determining the autocorrelation of the signal, algorithms such as a Levinson-Durbin algorithm may be provided to find an efficient solution to the least mean-square modeling problem and use the solution to provide the speech manipulation for the signal. Thus, according to embodiments, the entity 102 may provide an identifying of a periodic structure and a manipulating of at least a part of the periodic structure. According to embodiments, manipulating the periodic structure may include a removing of at least one of the repetitive periodic structures.

The encoding provided by entity 102 may be a loss-less or a lossy encoding. According to one embodiment, the encoding may be a PCM (pulse code modulation) based encoding such as a DPCM (differential pulse code modulation) or a ADPCM (adaptive DPCM) based encoding including encoding according to any one of the ITU-T standards G.7XX where X may be replaced by numbers from 1 to 9. G.7XX standards include for example standards G.721, G.722, G.726 and G.729. In other embodiments, proprietary codecs may be used. For example, according to one embodiment, proprietary codecs may be used for DTAMs (Digital Telephone and Answering Machines).

It is to be understood that the entity 102 may be implemented in hardware, software, firmware or any combination thereof.

The entity 102 is coupled to a memory 104 for storing the information contained in the output signal of entity 102. Memory 102 may be any form of memory including volatile or non-volatile memory. For example, memory 104 may include Flash memory, a hard disk, a disk drive, magnetic memory, phase-change memory, RAM, DRAM, and DDRAM etc. Furthermore, memory 104 may be external memory or internal memory.

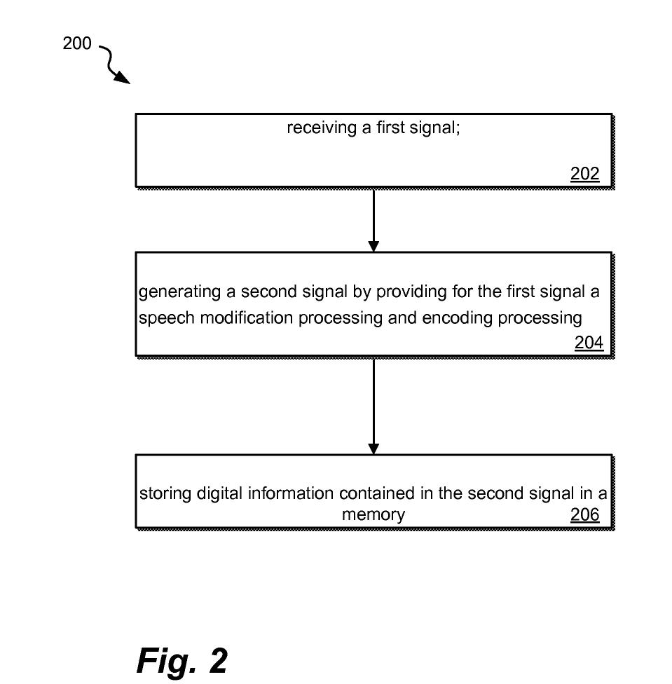

A basic flow diagram 200 according to an embodiment of the present invention will now be described with respect to FIG. 2. In 202, a first signal is received. The first signal may be any kind of voice signal such as a voice signal provided in a phone call, a voice signal of a user talking to a voice recording device, or any other voice signal. The first signal may be received for example from an A/D converter coupled to a microphone, from a communication channel connecting remote users or from a processor processing or extracting voice data from other data etc. The first signal may comprise frames, cells or other digital data structures with voice data. According to embodiments, the first signal is in the form of linearly quantisized samples.

In 204, a second signal is generated by providing for the first signal a speech modification processing and encoding processing. As outlined above, the speech processing and encoding may be separated or may be combined to provide simultaneous speech modification and encoding. In 206, the digital information contained in the second signal is then stored in a memory. It is to be noted that the second signal contains the voice signal information after the speech processing and encoding in a compressed form allowing reducing the size requirements for the memory provided to store the information contained in the second signal.

In order to recover the first signal from the memory, the second signal is retrieved from the memory by outputting the stored digital information corresponding to the second signal. The first signal is then recovered by providing to the second signal a decoding processing and a reverse speech manipulation processing. The decoding processing is the reverse of the encoding processing applied during generating the second signal. The reverse speech manipulation processing is the reverse of the speech manipulation processing applied during generating the second signal. For example, the reverse speech manipulation processing may be a slow-playback processing when the speech manipulation processing during the generation of the second signal is a fast-playback processing. In the slow-playback processing, periodic segments, for example repetitive pitches of vocals, which have been removed during the fast-playback processing are added to the signal by repeating (adding) the part of the periodic structure which has not been removed during the fast-playback.

According to one embodiment, information such as record parameters, frame coding parameter and information related to the voice signal parts removed during the speech manipulation processing, for example the number of pitch periods that have been consecutively removed in the speech manipulation, or other control information such as a compression coefficient or a compression rate of the speech manipulation used during the speech manipulation processing in 204 may be used in the reverse speech manipulation processing to recover the first signal. This allows a fast recovering of the first signal from the memory with high quality. This information may be also stored in the memory. Furthermore, when the encoding and speech manipulation is combined and simultaneously performed as outlined above, parameters related to the combined encoding and speech manipulation may be stored in the memory and may be used in the retrieving of the first signal.

It is to be noted that in view of the processing described above, the retrieved first signal may not exactly be identical to the first signal. For example, if one or more periodic repetitions of a vocal sound are removed the adding of one or more times the stored periodic part may not result in an identical signal. However, the quality of the retrieved signal may for a user identical or not significantly lower than the original first signal.

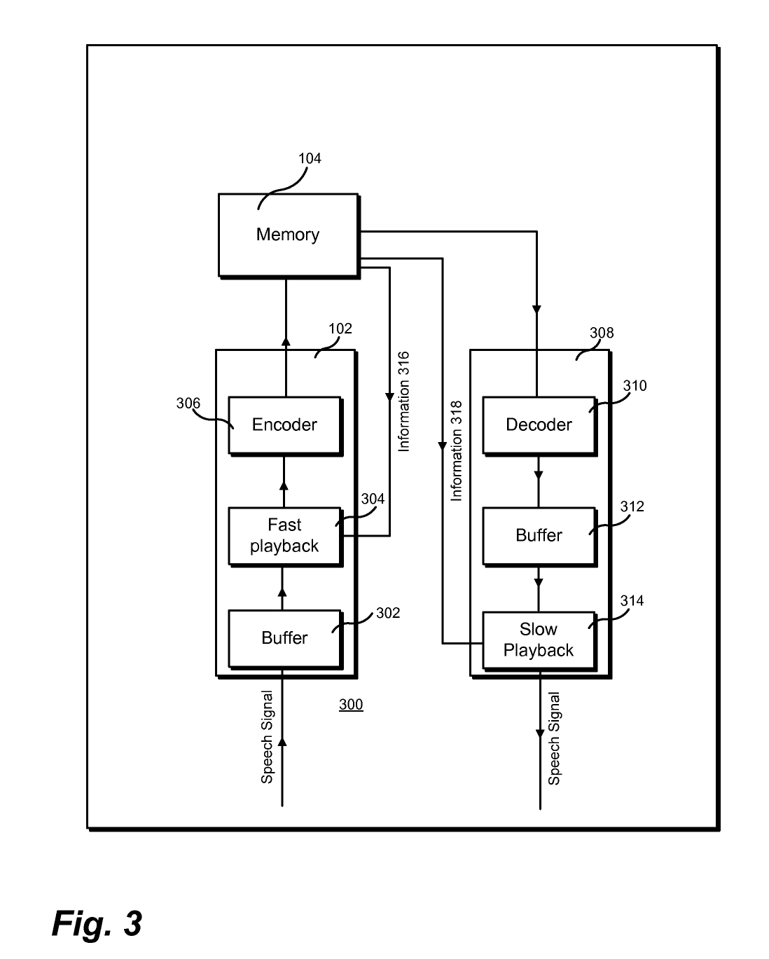

Referring now to FIG. 3, an embodiment wherein the encoding and speech manipulation is sequentially performed will be described.

FIG. 3 shows an apparatus 300 comprising the entity 102 to provide encoding and speech manipulating. According to this embodiment, the entity 102 comprises a buffer 302 to receive a speech signal, a fast-playback block 304 coupled to an output of the buffer 302 and an encoding block 306 coupled to an output of fast-playback block 304. The encoding block 306 is coupled to the memory 104 to store the output signal of encoding block 306.

The apparatus 300 further comprises an entity 308 to provide the reverse processing when the speech signal is retrieved from memory 104. The entity 308 comprises a decoder block 310, a buffer 312 and a slow-playback block 314. The decoder block 310 is coupled to the memory 104. An input of buffer 312 is coupled to an output of decoder block 310. Furthermore, the slow-playback block 314 is coupled to an output of buffer 312.

In operation, a speech signal provided to apparatus 300 is first buffered in buffer 302 and then transferred to the fast-playback block 304. In the fast-playback block 304 the speech signal is manipulated by applying a fast-playback algorithm to the signal. The fast-playback algorithm may for example include a LPC algorithm or any other fast-playback algorithm as described above. The speech manipulated output signal of the fast-playback block is transferred to the encoding block to encode the speech manipulated signal. In the encoding block, the speech manipulated signal is processed by an encoding algorithm which may for example include a PCM (pulse code modulation) based encoding such as a DPCM (differential pulse code modulation) or a ADPCM (adaptive DPCM) based encoding including encoding according to any one of the ITU-T standards G.7XX where X may be replaced by numbers from 1 to 9. G.7XX standards include for example standards G.721, G.722, G.726 and G.729.

The encoded output signal of the encoding block is then transferred to the memory 104 to store the compressed speech information contained therein.

To recover the speech signal, the compressed speech information output by the memory 104 and transferred to the decoding block 310. The decoding block provides the reverse of the encoding processing of encoding block 306. The output signal of the encoding block 310 is then buffered in buffer 312 and transferred to the slow-playback block 314. The slow-playback block 314 provides the reverse of the processing executed in the fast-playback block 304 to regain the speech signal.

For example, when in the fast-playback processing a first number of repetitive pitches in a vocal are discovered and removed, the same number of repetitive pitches can be added to the vocal in the slow-playback processing in order to regain the original speech signal.

According to the embodiment of FIG. 3, information 316 related to the fast-playback processing and information 318 related to the slow-playback processing may be stored in the memory 104. The fast-playback block may access the information 316 for the fast-playback processing to manipulate the speech signal and the slow-playback block may access the information 318 for the slow-playback processing to regain the speech signal. Information 316 and 318 may be related to each other. For example, according to one embodiment information 316 may include one or more record parameters such as a predefined or desired value for the speech compression factor or a maximum number of consecutively removed repetitive pitches. Based on the information 316, the fast-playback algorithm in the fast-playback block then identifies periodic quasi-stationary segments in the speech stream and the redundant segments are removed according to the algorithm resulting in an output speech stream which is compressed in time. The value of the desired compression, e.g. 0.5, and/or how many pitch periods can be removed consecutively may be preset within the algorithm. This information 318 includes playback parameters which are transferred to the slow-playback block 316. The fast-playback algorithm is then subject to similar but inverse rules, e.g. an expansion of factor 2 when the compression factor stored in memory 104 is 0.5.

It is to be noted that according to other embodiments, the information 316 and 318 may be stored in a separate memory. Furthermore, it is to be noted that a controller may be provided in order to control the transferring of the information 316 and 318 to the fast-playback block 304 and the slow-playback block 314, respectively. The controller may also provide other tasks such as providing the compression and expansion factor stored in the memory 104 adaptive based for example on the available capacity of free memory space in memory 104. To this end, the controller may monitor the size of free memory space in the memory 104 and adapt the compression factor and expansion factor in time. The adapted expansion parameters or other parameters may be stored in memory 104 or any other memory to obtain for each speech segment the correct expansion factor when the speech signal is retrieved from the memory 104.

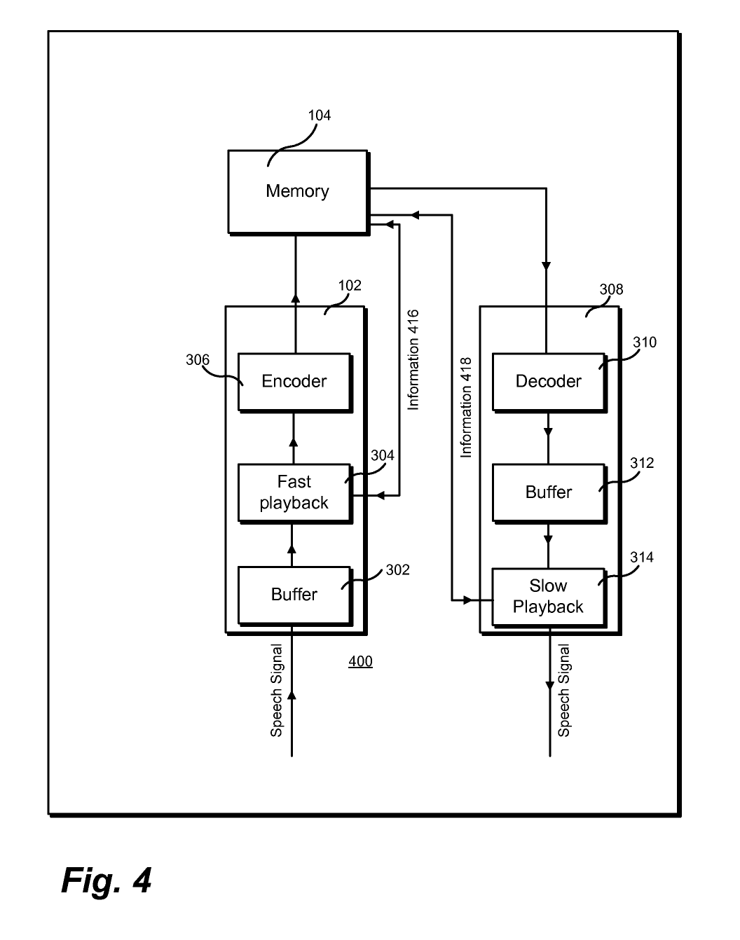

A further embodiment will now be described with respect to FIG. 4. FIG. 4 shows an apparatus 400 similar to the apparatus 300 of FIG. 3. However, distinguished from apparatus 300, in the apparatus 400 information 416 may be transmitted bidirectional to the fast-playback block 304. Information 416 may for example include recording information such as a compression factor which may be transferred from the memory 104 to the fast-playback block 304. In the reverse direction, i.e. from the fast-playback block 304 to the memory 104, information 416 may include frame encoding information. For example, according to one embodiment, when the fast-playback algorithm identifies periodic quasi-stationary segments in the speech stream and removes the redundant segments according to the algorithm, the encoded speech frames that have been manipulated and/or the information about the number of pitch periods extracted with the fast-playback algorithm are monitored and marked. This frame encoding information is transferred to the memory 104 and may be stored in memory 104 within the encoded frame or separate from the encoded frame. According to further embodiments, information 416 may include information about the increase/decrease in the pitch amplitude which is also monitored at the fast-playback block 304 and transferred to the memory 104. According to other embodiments, the information 416 transmitted by the fast-playback block may be stored in memory separate from memory 104 such as in a memory of a controller controlling the bidirectional transmission of the information.

Furthermore, in the apparatus 400 information 418 may be transmitted bidirectional to slow-playback block 416. Information 418 transmitted to the slow-playback block 314 may include the expansion factor used within the slow-playback processing wherein the expansion factor is correlated to the compression factor by having the reciprocal value of the compression factor. In the reverse direction. Furthermore, according to embodiments, the information 418 transmitted to the slow-playback block 314 includes the number of pitches removed from the original speech signal and/or stored information about the change in pitch amplitude if these information has been monitored by the fast-playback block 304 and stored. Thus, in the apparatus 400 a part of the information 418 transferred to the slow-playback block 314 and used for extracting the speech signal therein is based on or correlated to information 416 monitored by the fast-playback block 304.

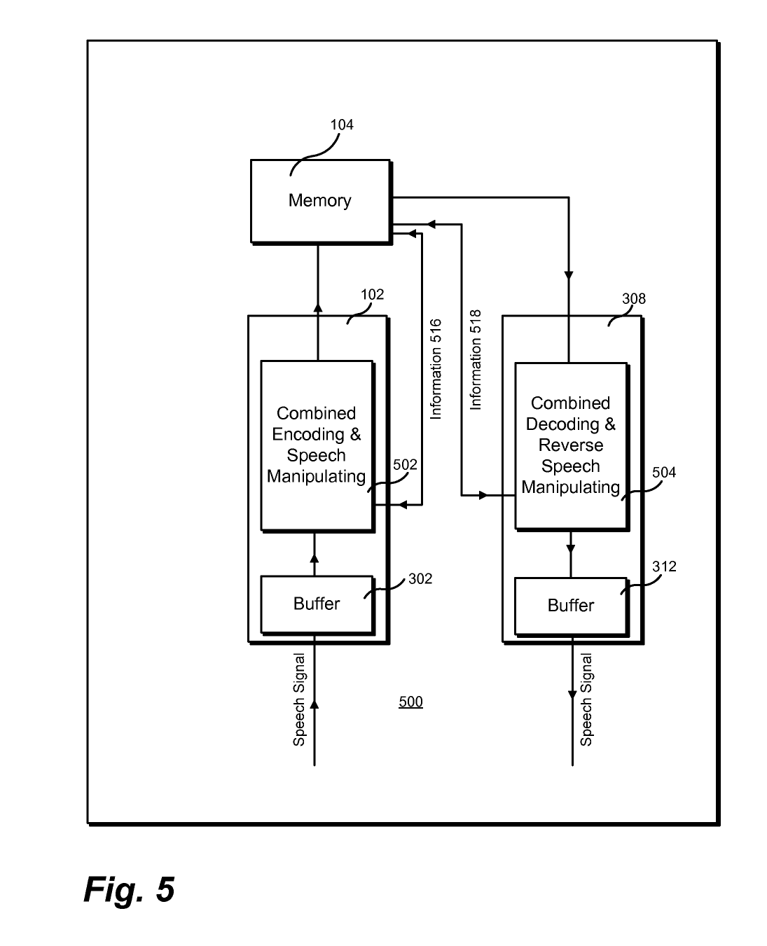

A further embodiment implementing combined speech manipulating and encoding will be described with respect to FIG. 5.

FIG. 5 shows an apparatus 500 implementing combined encoding and speech manipulating together with combined decoding and reverse speech manipulating. To provide the combined encoding and speech manipulating, a block 502 is provided coupled to the buffer 302. The output of block 502 is coupled to the memory 104 to store the compressed signals output by block 502. Combined decoding and reverse speech manipulating is provided by a block 504 coupled to memory 104 to receive the compressed signals from memory 104 and to expand the compressed signals by combined decoding and reverse speech manipulating to restore the original speech signal. Similar to the embodiments of FIGS. 3 and 4, information 516 may be transmitted from memory 104 to block 502 to set processing parameters such as a desired compression rate etc. Furthermore, information 516 may be transmitted by the block 502 to store information related to the processing of frames.

According to one embodiment, multiple frames are processed in block 502 simultaneously. Processing in block 502 includes determining of a spectral distance between subsequent frames, selecting of frames to be removed based on the determined spectral distance and encoding of the frames which have not been removed. The spectral distance may for example include a difference of the frames in pitch frequency and amplitude. If the spectral distance between two consequent frames is below a predetermined threshold, i.e. is small enough, the first frame can be used as a reference for a following second frame or a plurality of following frames. The second frame or the plurality of following frame is then removed and information indicating the difference between the first and second frame or the first frame and the plurality of following frames is provided and stored in memory 104. This information is then transferred to block 504 to allow restoring of the second frame or the plurality of frames. In block 504, the decoder algorithm generates the second frame or the plurality of frames that have been removed in block 502 based on the first frame and the information indicating the difference between the first and second frame or the first and the plurality of frames.

In the above description, embodiments have been shown and described herein enabling those skilled in the art in sufficient detail to practice the teachings disclosed herein. Other embodiments may be utilized and derived there from, such that structural and logical substitutions and changes may be made without departing from the scope of this disclosure.

This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation such as an analog signal representation, a digital signal representation, a modulation onto carrier signals etc. Furthermore the terms “coupled” or “connected” may be interpreted in a broad sense not only covering direct but also indirect coupling.

The accompanying drawings that form a part hereof show by way of illustration, and not of limitation, specific embodiments in which the subject matter may be practiced.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving a first signal;
generating a second signal by providing for the first signal a speech modification processing and encoding processing; and
storing digital information contained in the second signal in a memory.

2. The method according to claim 1, wherein the speech modification processing comprises:
identifying a periodic structure in the first signal; and
manipulating the periodic structure.

3. The method according to claim 2, wherein the manipulating the periodic structure comprises removing at least a part of the periodic structure.

4. The method according to claim 1, wherein the generating of a second signal comprises providing a fast-playback processing and an audio encoding processing for the first signal.

5. The method according to claim 1, wherein the generating of a second signal comprises:
providing a fast-playback processing to the first signal to generate a third signal; and
generating the second signal by audio encoding the third signal.

6. The method according to claim 1, wherein the generating of a second signal comprises:
providing a fast-playback processing during an encoding processing of the first signal to generate the second signal.

7. The method according to claim 1, further comprising:
retrieving the second signal from the memory; and
providing a decoding processing and a reverse speech modification processing for the second signal to retrieve the first signal.

8. The method according to claim 7, wherein the reverse speech modification processing comprises adding at least one periodic segment to the second signal.

9. The method according to claim 4, wherein the fast-playback processing is a fast speed playback processing with variable compression rate.

10. The method according to claim 4, wherein the fast-playback processing is a LPC processing and wherein the encoding is a G.7XX audio encoding processing.

11. An apparatus comprising:
an input to receive a first signal;
an entity coupled to the input to provide speech manipulating processing and encoding processing for the first signal; and
a memory coupled to the entity.

12. The apparatus according to claim 11, wherein the entity is configured to provide fast-playback processing and audio encoding processing.

13. The apparatus according to claim 11, wherein the entity comprises:
a device coupled to the input to provide fast-playback processing for the first signal;
an encoder coupled to the fast-playback device.

14. The apparatus according to claim 11, wherein the entity is configured to provide simultaneously fast-playback processing and encoding processing for the first signal.

15. The apparatus according to claim 11, further comprising a device coupled to the memory to provide decoding and slow-playback processing.

16. The apparatus according to claim 11, wherein the speech manipulating processing includes identifying and manipulating of a periodic structure.

17. A communication system comprising:
an input to receive a signal; and
a recording device to record the signal, the recording device comprising:
an entity coupled to the input to provide speech-manipulating processing and encoding processing for the signal, and
a memory coupled to the entity to store information contained in the speech-manipulated and encoded signal.

18. The system according to claim 17, wherein the entity is configured to provide speech-modification processing by identifying a periodic structure of the first signal and removing of at least a part of the periodic structure.

19. The system according to claim 17, wherein the entity is configured to provide speech-modification processing by providing a fast-playback processing for the first signal.

20. The system according to claim 17, the system comprising a further entity to provide decoding processing and slow-playback processing for the information stored in the memory.

21. The system according to claim 17, wherein the entity is configured to provide LPC speech-modification processing and G.7XX audio encoding processing.

22. A device comprising:
an input to receive a first signal;
means for generating a second signal by providing for the first signal a speech modification processing and encoding processing; and
a memory for storing digital information contained in the second signal.

23. The device according to claim 22, wherein the means for generating a second signal is configured to provide speech modification processing by removing of at least a part of a periodic structure of the first signal.

24. The device according to claim 22, wherein the means for generating the second signal is configured to provide speech-modification processing by providing a fast-playback processing for the first signal.

25. The device according to claim 22, further comprising means for providing decoding and slow-playback processing for the information stored in the memory.
